(19) United States
(12) Patent Application Publication
(10) Pub. No.: US 2018/0168126 A1
(43) Pub. Date: Jun. 21, 2018

(54) Pet Food Feeding System

(71) Applicant: Andy H. Gibbs, Tucson, AZ (US)

(72) Inventor: Andy H. Gibbs, Tucson, AZ (US)

(21) Appl. No.: 15/899,296

(22) Filed: Feb. 19, 2018

Related U.S. Application Data
(63) Continuation-in-part of application No. 14/987,080, filed on Jan. 4, 2016.
(60) Provisional application No. 62/109,188, filed on Jan. 29, 2015.
(60) Provisional application No. 62/460,168, filed on Feb. 17, 2017.

(51) Int. Cl. A01K 5/01; A01K 7/00; B65D 25/04; B65D 77/20; A23K 50/48; A23K 20/00

(52) U.S. Cl. CPC A01K 5/0121; A01K 7/00; B65D 25/04; B65D 85/70; A23K 50/48; A23K 20/00; B65D 77/2024

(57) ABSTRACT

A pet food feeding system for effectively distributing and dispensing food to an animal in a controlled manner. The pet food feeding system generally includes a container having a floor, a sidewall extending upwardly from the floor, and an upper opening defined by an upper perimeter of the sidewall. The floor and sidewall define an interior space that receives a volume of dry kibble food pellets. The floor includes a plurality of projections that extend upwardly into the interior space where the pellets fit between thereof. A top closure may be attached to the upper perimeter of the sidewall in a sealed manner to seal the dry kibble food pellets within the interior space.

### CROSS REFERENCE TO RELATED APPLICATIONS

The present application is a continuation-in-part of U.S. application Ser. No. 14/987,080 filed on Jan. 4, 2016 (Docket No. GIBB-070), which claims priority to U.S. Provisional Application No. 62/109,188 filed Jan. 29, 2015 (Docket No. GIBB-057). The present application also claims priority to U.S. Provisional Application No. 62/460,168 filed Feb. 17, 2017 (Attorney Docket No. GIBB-076). Each of the aforementioned patent applications, and any applications related thereto, is herein incorporated by reference in their entirety.

### STATEMENT REGARDING FEDERALLY SPONSORED RESEARCH OR DEVELOPMENT

Not applicable to this application.

### BACKGROUND

### Field

Example embodiments in general relate to a pet food feeding system for effectively distributing and dispensing food to an animal in a controlled manner.

### Related Art

Any discussion of the related art throughout the specification should in no way be considered as an admission that such related art is widely known or forms part of common general knowledge in the field.

Companion dogs and cats live in more than 80 million households within the United States, and the various methods of packaging pet foods are well known to pet food manufacturers and pet owners alike. Generally, pet food is packaged in cans, bags or boxes that are intended to hold enough food for multiple feedings. Pet owners have long practiced daily feeding their pets by transferring a certain amount of pet food from the bulk container to a feeding bowl. These methods of manufacturing, packaging and feeding pets have many unresolved shortcomings.

First, bulk pet food containers, once opened, allow for oxidation of the food remaining in the container. Oxidation breaks down food nutrients starting at the moment the food containers are first opened. Food given to pets days or weeks after initially opening the container is of lower nutrient value compared to food in the newly-opened package.

Second, consumers are not skilled in determining the proper food portions for each animal, and more often over-feed their pets. This is evidenced by a pet obesity rate exceeding fifty percent, and obese pets will die earlier, and have more expensive medical care than healthy-weighted pets. Current packaging methods to not properly govern portion control for each unique pet.

Third, the typical method of feeding involves transferring food from a food container to a pet food bowl. More often than not, the bowl of food is left on the floor so the pet can consume all of the food over time. The bowl is typically not touched by the pet owner until the next feeding time. Food particles and pet saliva remaining on the bowl for extended periods of time is exceedingly non-hygienic, and fosters bacteria and mold growth on the bowl.

Forth, many large breed pets are prone to “bloat”, a term used to describe gastric dilation and volvulus syndrome (GDV), a potentially life threatening stomach condition. Since gulping food down quickly can trigger bloat, one recommended method of reducing the probability of a pet experiencing GDV is to slow down its consumption of food. There are many uniquely designed pet food bowls commercially available that provide for complex interior surfaces intended to make it more difficult for a pet to consumer the food, but none of these modified food bowls are ideal for every size of dry kibble food nugget, or for the various canine snout geometry of the many breeds of dogs. Further, these food bowls are not conducive for use with wet food that packs around the interior geometry and remains uneaten. Increased residual food in the bowl fosters bacteria and mold growth.

Finally, none of the bulk food packages are convenient for traveling with the pet. Travelers must estimate the amount of food needed for the travel duration, and transfer the food from one package to a temporary package for traveling. There is little probability that precisely the right quantity of food for the number of feeding days will be packaged for travel; the travel package will most often contain too much or too little food for the pet.

Therefore, there is significant commercial value and consumer convenience in providing a correctly portioned pet food serving in a perpetually clean serving bowl that contained features that inhibited the occurrence of nutrient loss through oxidation, GDV or mold and bacteria growth.

### SUMMARY

An example embodiment is directed to a pet food feeding system. The pet food feeding system includes a container having a floor, a sidewall extending upwardly from the floor, and an upper opening defined by an upper perimeter of the sidewall. The floor and sidewall define an interior space that receives a volume of dry kibble food pellets. The floor includes a plurality of projections that extend upwardly into the interior space where the pellets fit between thereof. The plurality of projections are spaced apart at a distance and height sufficient so that the dry kibble food pellets are positionable between the plurality of projections in a manner that ensures an animal is required to take more time to pull the dry kibble food pellets from the container to slow the eating process. A top closure may be attached to the upper perimeter of the sidewall in a sealed manner to seal the dry kibble food pellets within the interior space.

The various embodiments disclose a manufactured pet food and package and packaging method that provides for delivering the correct daily food portions for various sized pet dogs and cats in a clean feeding and watering serving bowl that is disposed of after each feeding session. Further, the various embodiments of the present invention provide for geometric features within the feeding bowl that are appropriately sized and positioned for slow the consumption of every type and size of dry kibble and wet food, thereby reducing the potential for an animal to experience GDV.

There has thus been outlined, rather broadly, some of the embodiments of the pet food feeding system in order that the detailed description thereof may be better understood, and in order that the present contribution to the art may be better appreciated. There are additional embodiments of the pet food feeding system that will be described hereinafter and that will form the subject matter of the claims appended hereto. In this respect, before explaining at least one embodiment of the pet food feeding system in detail, it is to be understood that the pet food feeding system is not limited in its application to the details of construction or to the arrangements of the components set forth in the following description or illustrated in the drawings. The pet food feeding system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is an exemplary diagram illustrating an isometric view of a single serve pet food package comprising a formed food package in accordance with an example embodiment.

FIG. 2 is an exemplary diagram illustrating a top view of a single serve pet food package comprising a formed food package with a package top closure in accordance with an example embodiment.

FIG. 3 is an exemplary diagram illustrating a top view of the inner cavity of a single serve pet food package in accordance with an example embodiment.

FIG. 4 is an exemplary diagram illustrating a side view of a single serve pet food package in accordance with an example embodiment.

FIG. 5 is an exemplary diagram illustrating an end view of a single serve pet food package in accordance with an example embodiment.

FIG. 6 is an exemplary diagram illustrating a top inside view of a single serve pet food package containing food in accordance with an example embodiment.

FIG. 7 is an exemplary diagram illustrating a top inside view of a variation of a single serve pet food package containing food in accordance with an example embodiment.

FIG. 8 is an exemplary diagram illustrating a top inside view of another variation of a single serve pet food package containing large kibble food in accordance with an example embodiment.

FIG. 9 is an exemplary diagram illustrating a top inside view of a yet another variation of a single serve pet food package containing food wet in accordance with an example embodiment.

FIG. 10A is an exemplary diagram illustrating a top view of a substantially round holder for a single serve pet food package in accordance with an example embodiment.

FIG. 10B is an exemplary diagram illustrating a top view of a substantially round package server in accordance with an example embodiment.

FIG. 10C is an exemplary diagram illustrating a side view of a substantially round holder for a single serve pet food package in accordance with an example embodiment.

FIG. 10D is an exemplary diagram illustrating a side view of a substantially round single serve pet food package in accordance with an example embodiment.

FIG. 10E is an exemplary diagram illustrating a sectional view of a substantially round food package holder in accordance with an example embodiment.

FIG. 11A is an exemplary diagram illustrating a top view of a two cavity top tray of single serve pet food package with pet food in accordance with an example embodiment.

FIG. 11B is an exemplary diagram illustrating a top view of a one cavity bottom tray of single serve pet food package with pet food in accordance with an example embodiment.

FIG. 11C is an exemplary diagram illustrating a side view of a two cavity top tray and nestable one cavity bottom tray of single serve pet food package in accordance with an example embodiment.

FIG. 12 is an exemplary diagram illustrating an isometric view of tray variations of a nestable single serve pet food trays, pet food, and a raised food package server in accordance with an example embodiment.

FIG. 13 is an exemplary diagram illustrating an isometric view of tray variations of a nestable single serve pet food trays, pet food, packaged food topper, and a raised food package server in accordance with an example embodiment.

FIG. 14 is an exemplary diagram illustrating an isometric view of one variation of a multi-cavity, single serve pet food tray and pet food in accordance with an example embodiment.

FIG. 15 is an exemplary diagram illustrating a flow chart describing one feeding process using a single serve pet food container in accordance with an example embodiment.

FIG. 16 is an exemplary diagram illustrating a flow chart describing one feeding process using a nestable, single serve pet food container in accordance with an example embodiment.

FIG. 17 is an exemplary diagram illustrating a flow chart describing one feeding process using a variation of a nestable, single serve pet food container in accordance with an example embodiment.

FIG. 18 is an exemplary diagram illustrating a flow chart describing one feeding process using a variation of a nestable, single serve pet food container with a pre-packaged food topper in accordance with an example embodiment.

FIG. 19A is an exemplary diagram illustrating a chart listing a selection of weight-based daily caloric requirements of pet dogs in accordance with an example embodiment.

FIG. 19B is an exemplary diagram illustrating a chart matching a food package size to a dog size in accordance with an example embodiment.

FIG. 19C is an exemplary diagram illustrating a chart showing the caloric content of various sizes of dog food packages in accordance with an example embodiment.

FIG. 20 is an exemplary diagram illustrating a flow chart describing one manufacturing process for producing a disposable, single serve pet food container in accordance with an example embodiment.

FIG. 21a is an exemplary diagram illustrating the skeletal structure of a domesticated animal with a traditional food bowl in accordance with an example embodiment.

FIG. 21b is an exemplary diagram illustrating the skeletal structure of a domesticated animal with an improved food bowl in accordance with an example embodiment.

FIG. 22a is an exemplary diagram illustrating the size of dry kibble food relative to coin sizes in accordance with an example embodiment.

FIG. 22b is an exemplary diagram illustrating the size of dry kibble food relative to other kibble sizes in accordance with an example embodiment.

FIG. 22c is an exemplary diagram illustrating the two variations of canned dog food in accordance with an example embodiment.

FIG. 23 is an exemplary diagram illustrating three views of an improved food bowl in accordance with an example embodiment.

FIG. 24 is an exemplary diagram illustrating three views of an improved round food bowl with a food obstacle in accordance with an example embodiment.

FIG. 25 is an exemplary diagram illustrating a variation of an improved food bowl in accordance with an example embodiment.

FIG. 26 is an exemplary diagram illustrating an isometric view of an improved rectilinear food bowl with an insert comprising food obstacles in accordance with an example embodiment.

FIG. 27 is an exemplary diagram illustrating a sectional view through a typical insert with integral obstacles in accordance with an example embodiment.

### DETAILED DESCRIPTION

It should be noted that although substantially round and rectangular pet food bowls are shown herein, and that although tear-off paper container covers are shown as the production closure means for bowls with food contained therein, any reasonable shape of pet food bowl, any commonly known production methods of closing and sealing a food container, and any materials typically used in the production of food in food containers may be used interchangeably with no effect to the novelty of the various embodiments herein, and any specific reference to materials, closure methods or shapes of bowls as a production food package as described herein may also refer to any other shape, closure method or materials as just described.

The drawings herein are for illustrative purposes only, and drawings should be broadly interpreted, recognizing the many variances in food packaging manufacturing materials and processes, the broad variation in pet food characteristics, and the many different sized pets requiring a broad range of daily caloric and nutritional consumption. To describe the nearly limitless combination of materials, geometries, food and pet characteristics that exist and which may be used in the various embodiments would be voluminous and unduly burdensome, yet to do would only serve to reinforce the useful novelty of the various embodiments.

Further, the use of a resilient sheet material is described herein as a top enclosure for a food package is not meant to be limiting, and any type of sheet material, metal or thermoformed material may be used, and the method of attaching the top enclosure material to the food package may include use of adhesives, locking features of interference-fit components, heat staking, crimping, mechanical fastening such as a round threaded top and threaded mating bottom components of a food container interchangeably without deviating from the spirit of the novel functions and methods of the various embodiments.

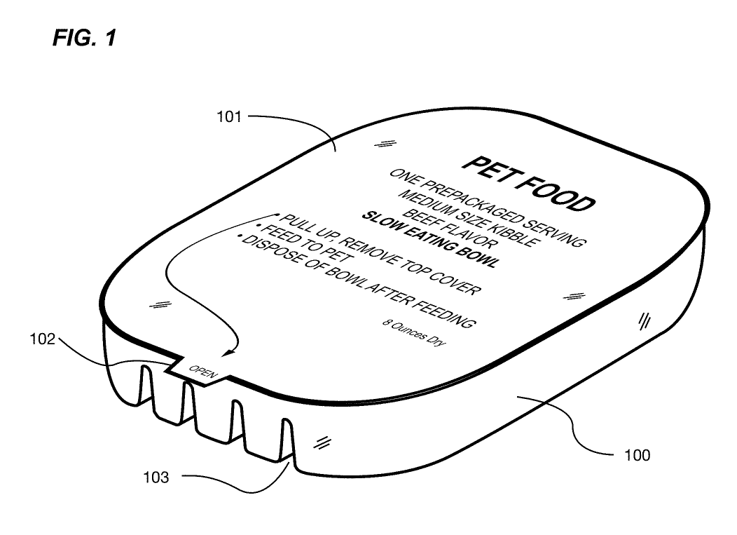

FIG. 1 is an exemplary diagram illustrating an isometric view of a single serve pet food package in accordance with an example embodiment comprising a formed food package 100, a package top closure 101, an opening tab 102, and a plurality of formed depressions that create interior compartment separators 103. As previously described, the formed food package and top closure may be manufactured from any material meeting the functional requirements of the various embodiments that also meet the regulatory approval for use in food packaging.

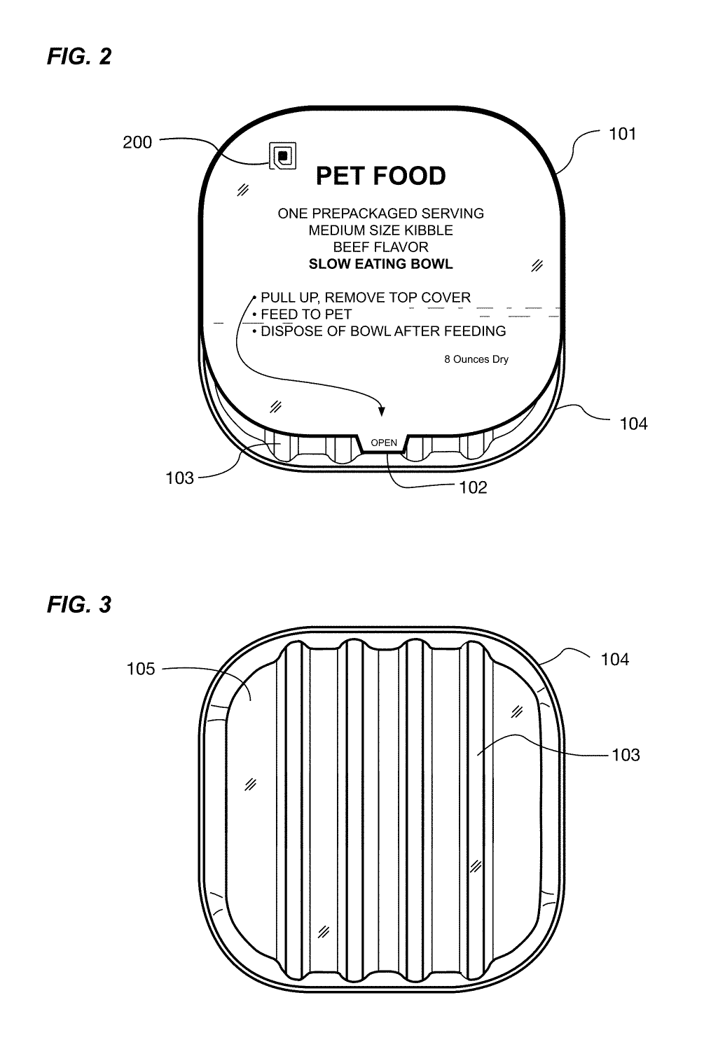

FIG. 2 is an exemplary diagram illustrating a top view of a single serve pet food package comprising a formed food package with a package top closure 101 which, in practice, is sealed to a package top rim 104, the top closure shown partially opened by pulling on an opening tab 102.

As can be seen on the inside cavity, a plurality of compartment separators 103 are partially visible. A package identification ship 20 is shown applied to the package top closure, although the package identification chip may be reasonably applied to or integrated into any component of the packaging that will remain with the package at least until the food opened for feeding to an animal. The package identification chip may use well known technology such as a radio frequency identification (RFID) or near field communication (NFC) chip, or future technologies that may communicate important data about the food and package to a consumer wireless device.

A non-limiting list of data fields that may be contained in the memory of, and/or communicated to a wireless device from the package identification chip includes manufacturing date, plant number, lot number, food weight, package tare weight, food characteristics such as moisture content, nutritional or caloric content, and food preparation instructions.

FIG. 3 is an exemplary diagram illustrating a top view of the inner cavity of a single serve pet food package. More specifically, the package top closure FIG. 2., 101 having been removed in the present drawing reveals the top of package sealing rim 104, and an inner cavity of the formed food package comprising a plurality of food compartments 105 separated by a plurality of compartment separators 103.

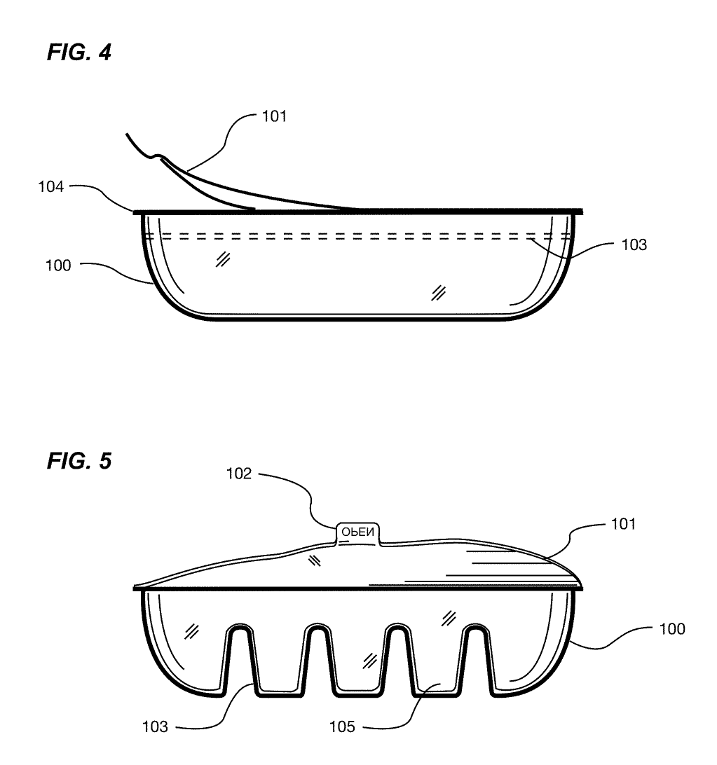

FIG. 4 is an exemplary diagram illustrating a side view of a single serve pet food package comprising a formed food package 100 having a top edge package sealing rim 104 to which a package top closure 101 is sealed during a manufacturing process after filling the package with food. Although obscured by the outer surface of the formed food package, the dotted line represents the approximate upper surface of the compartment separators 103, the distance between the top of the separator and the underside of the closed package top closure being small enough to prevent food from one food compartment from easily traveling into an adjacent compartment.

FIG. 5 is an exemplary diagram illustrating an end view of a single serve pet food package comprising a formed food package 100, a package top closure 101 shown partially opened by pulling the opening tab 102 in a direction away from the top of the food package. A series of undulations formed in the bottom surface of the formed food package create a plurality of interior compartment separators 103 and alternating food compartments 105 into which food is filled during the manufacturing process.

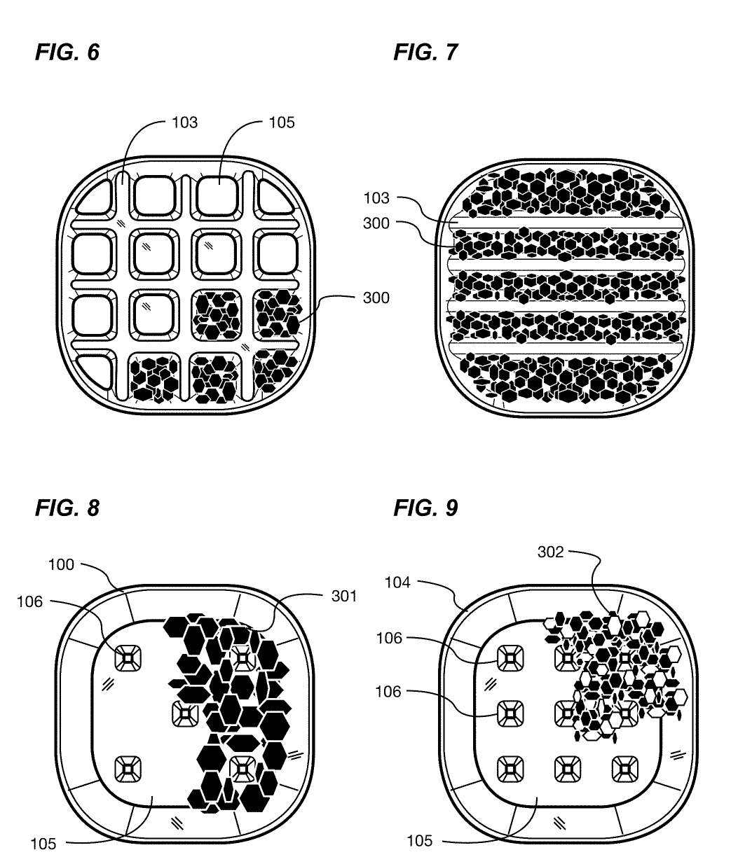

FIG. 6 is an exemplary diagram illustrating a top inside view of a single serve pet food package containing food. More specifically, it can be readily seen that a plurality of compartment separators 103 arranged in substantially a grid pattern form a plurality of substantially rectangular food compartments 105 into which small kibble food is filled during manufacturing.

The quantity and positioning of the food compartment separators preferably:

a. correlate to the size of the dry kibble food pellets 300, namely that large sized kibble food will be filled into a formed food package with larger food compartments and relatively fewer compartment separators, while small size kibble food would be filled into a formed food package with relatively smaller food compartments created by forming more compartment separators. The importance of the relative arrangement just described is, in part, to ensure that an animal is required to take more time to pull the kibble from the respective compartments, thereby slowing the eating process ad one means of reducing the occurrence of GDV, and

b. are formed to ensure that the depth of each food compartment relative to the width of each food compartment is of a sufficient ratio so as to accommodate the approximate average width of the snout (nose and mouth) of the anticipated size of the animal that will eat the single portion of food contained in the single serving container.

FIG. 7 is an exemplary diagram illustrating a top inside view of a variation of a single serve pet food package containing food. More specifically, a plurality of rows of food compartments containing small kibble food 300 are created by forming a plurality of substantially parallel compartment separators 103. It is sometimes preferred with certain kibble geometry or the anticipated eating style of the intended pet consumer to form channels of food that a pet will follow while eating, the channels forcing the animal to take a short break from gulping food while it moves its snout from one channel to another.

FIG. 8 is an exemplary diagram illustrating a top inside view of another variation of a single serve pet food package containing large kibble food 301. In the drawing, a plurality of castellations 106 extend upward from the inside bottom surface of the food compartment 105 thereby creating vertical barriers that an animal must navigate around during eating, thus slowing food consumption.

The relatively few castellations allow the dry large kibble food to move between the castellations as the pet attempts to eat. The interruption of the castellations force the animal to spend more time eating by moving the food about until it can grasp it for consumption.

FIG. 9 is an exemplary diagram illustrating a top inside view of a yet another variation of a single serve pet food package containing food wet.

It should be noted that none of the known, currently available food bowls with slow eating features easily accommodate the use with wet food that is typically provided in canned or pouch form. The primary reasons for not using available food bowls with slow eating features are:

a) that the features form small radii with the lower food bowl surface preventing the pet from accessing all of the food,

b) food that remains in the small radii where vertical features are formed to slow eating is a primary source of bacterial and mold growth,

c) that vertical features used for large kibble are too deep for wet food that spreads across the bottom of the bowl, and prevents wide snouted animals from reaching the food, and

d) that the use of such bowls required thorough cleaning immediately after feeding the animal, the cleaning being a difficult and inconvenient daily task for the pet owner.

Therefore, those skilled in the art will appreciate the advantage of combining a relatively high density of a plurality of short castellations 106 throughout the surface area of the food compartment 105 when the package is intended for production filling with wet pet food.

Further, they will appreciate that regardless of integrating large radii on the intersection of the castellations and bottom of the food compartment, cleaning will continue to be difficult, and their preference would be the disposal of the soiled formed food package after a single use eating session, and of feeding the animal in a subsequent eating session from a new clean formed food package with food.

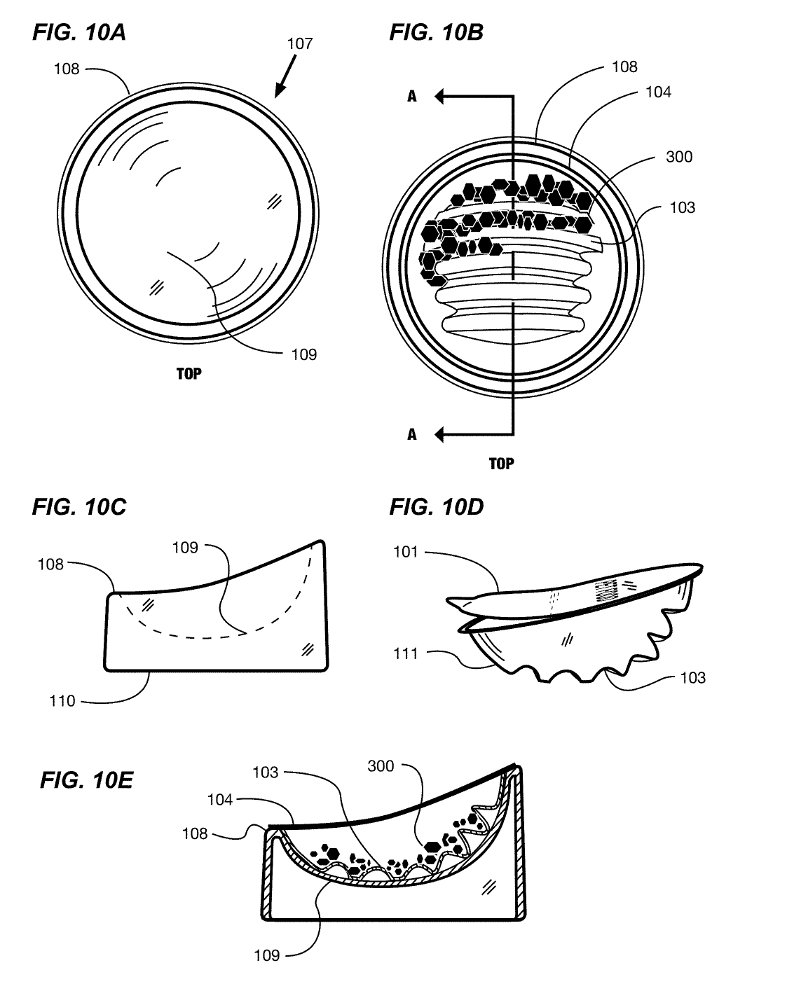

FIG. 10A is an exemplary diagram illustrating a top view of a substantially round holder for a single serve pet food package. Those familiar with the ubiquitous line of thermoformed Tupperware® food containers understand that such container are light weight. Similarly, a thermoformed pet food package may be light weight, the lack of weight resulting in a food package used as a one-time feeding bowl being moved wildly around a room at the pet “chases” the food contained therein.

Therefore, it is sometimes preferred to provide a holder for the light weight formed, single use food package. In the drawing, a substantially round package server 107 is shown with a server top rim 108, and a concave top surface 109 that is formed to receive a correspondingly curved single serving round feeding package.

FIG. 10B is an exemplary diagram illustrating a top view of a substantially round package server comprising a server top rim 108 into which a round package server with a package sealing rim 104, has been placed for serving food to an animal, the single serve pet food package containing small kibble food in food channels formed by intervening compartment separators 103.

FIG. 10C is an exemplary diagram illustrating a side view of a substantially round holder for a single serve pet food package comprising a server top rim 108 upon which the package sealing rim of a formed food package will be positioned, and a nonskid base 110 that inhibits the package serer from being pushed around the floor during eating. Although obscured from view by the outside surface of the round package server, the approximate concave surface of the server is shown by the dotted line 109.

FIG. 10D is an exemplary diagram illustrating a side view of a substantially round single serve pet food package. The lower curvature of the bottom or the round feeding package 111 substantially coincides with the inner concave surface of the round package server as just described. The round pet food package is manufactured with a package top enclosure 101 that will be removed by the pet owner prior to serving the food to the animal. A series of formed undulations on the bottom surface of the round serving package form interior compartment separators 103 as previously described.

FIG. 10E is an exemplary diagram illustrating a sectional view of a substantially round holder with a server top rim 108 and a server concave top surface 109. In practice, a round server package is inserted into the concave section of the package server so that the underside of the round server package is preferably equally supported by the server top rim 108 and concave top surface inside 109. The single serve pet food package is shown with compartment separators 103 separating compartments containing small kibble food 300, the benefits of which having been previously discussed in detail.

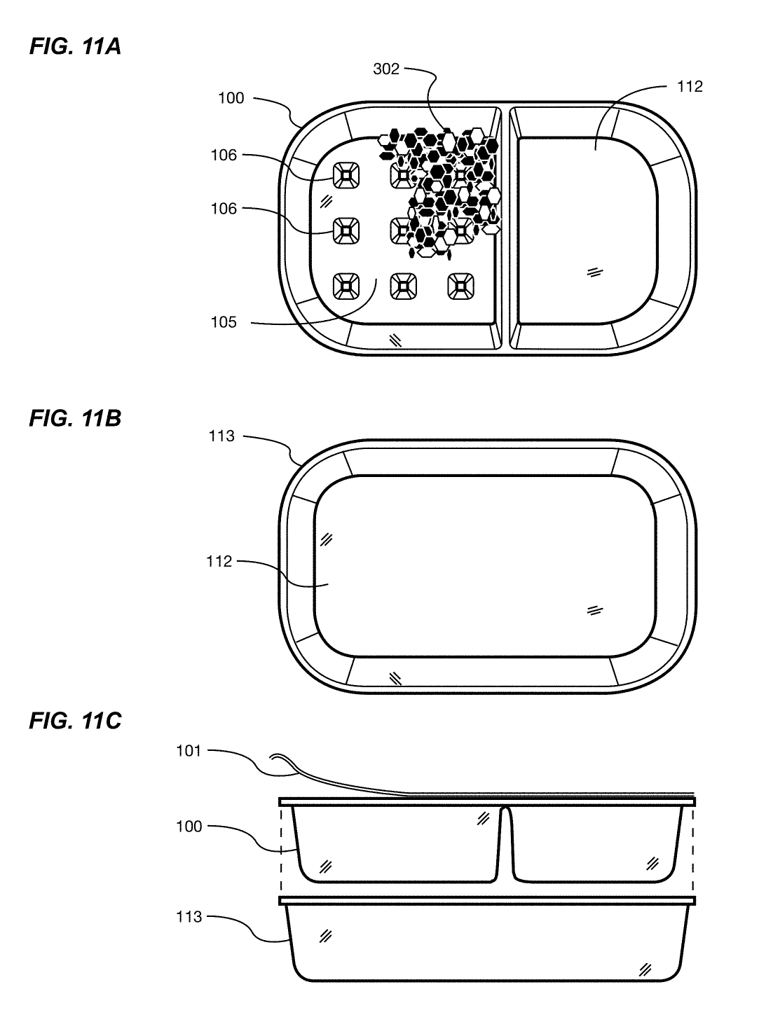

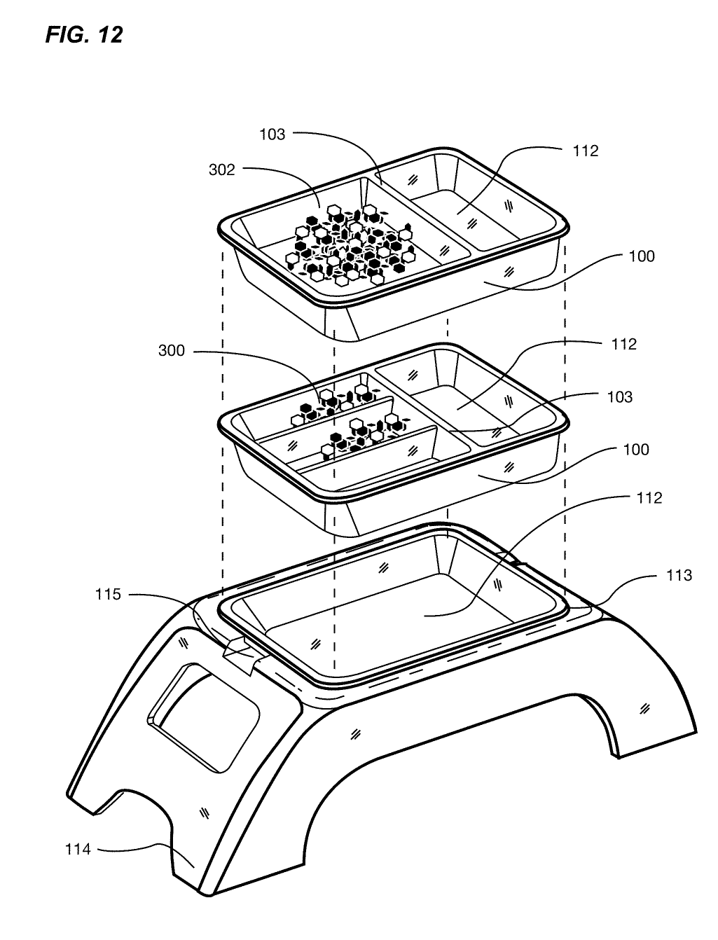

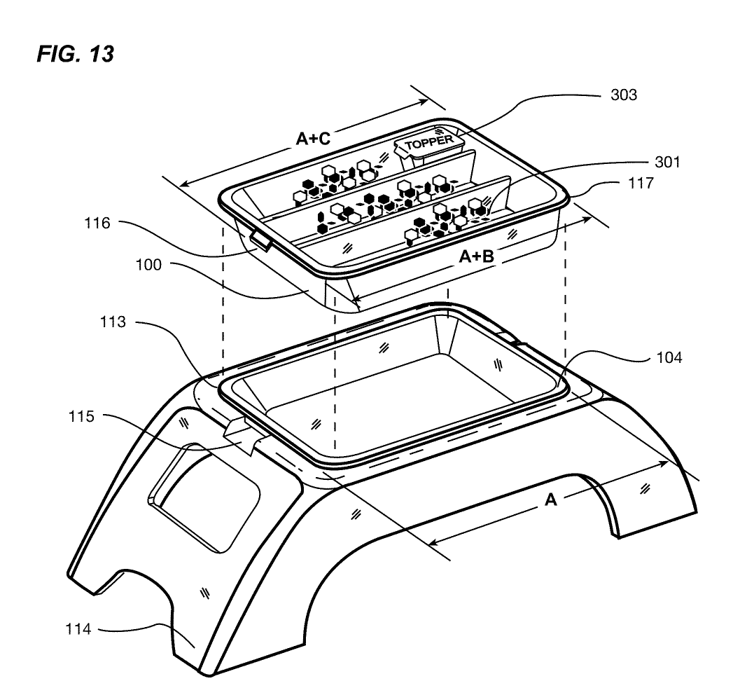

FIG. 11A is an exemplary diagram illustrating a top view of a two cavity top tray of single serve pet food package with pet food.

Those skilled in the art will strenuously argue the importance of a pet having fresh clean water immediately available while eating. In the drawing, a formed food package 100 comprises a large food compartment 105 and a water compartment 112. As can be seen, the food compartment comprises a plurality of castellations 106 that will slow the consumption of food, the benefits of which have been previously described, and wet food 302. In practice, the wet food would have substantially filled the food compartment 105, but for clarity, only a portion of the food compartment is shown filled with pet food.

When a new formed food package containing food is used to feed a pet, it is appreciated that the inner surfaces of the food compartment have been sterilized and free from harmful toxins that could be consumed. Similarly, the water compartment, being sealed under the same package top closure as the pet food, will also be in the most sanitary state for using as a clean bowl for fresh water.

FIG. 11B is an exemplary diagram illustrating a top view of a one cavity bottom tray of single serve pet food package with pet food. Animals need free access to water throughout the day. In a typical pet household the water bowl may be refilled many times during the day, and from day to day, without emptying and cleaning the bowl between fillings. This practice increases the danger of mold or bacteria forming on the bowl, and being consumed by the animal.

In one example embodiment, a large water bowl is provided that will accommodate a large portion, if not all of the pet's water needs throughout the day. By intention of function, the inner dimensions of the lower tray 113 are substantially the same as the outer dimensions of the double cavity food and water tray as described in FIG. 11A so that the two trays tightly nest together to minimize the package volume, an important component related to lower product shipping and handling costs, and more efficient food package storage for the pet owner.

FIG. 11C is an exemplary diagram illustrating a side view of a two cavity top tray and nestable one cavity bottom tray of single serve pet food package. As previously described, a nestable package would preferably contain an upper formed food package 100 with separate food and water compartments as in FIG. 11A, the upper tray having been filled with pet food and sealed with a package top closure 101 during the manufacturing process, and a lower water tray 113 that would be separated for use solely as a water tray after disposal of the empty food tray.

FIG. 12 is an exemplary diagram illustrating an isometric view of tray variations of a nestable single serve pet food trays, pet food, and a raised food package server 114 specifically intended to securely hold certain formed food packages for serving food to an animal during meal time.

The nestable multi-tray disposable formed food package and water tray have been previously described, in the drawing one variation of a multi-compartment upper formed food package 100 comprises only two compartments divided by one compartment separator 103. A water compartment 112 is intentionally empty upon opening by a pet owner, allowing the pet owner to fill with fresh water. A food compartment is shown containing wet food 302, and no castellations. GDV rarely effects small animals, so in small-sized formed food packages, the importance of castellations of separate food compartments diminishes significantly.

Therefore, the configuration of the two-compartment formed food package is appropriate for small pets.

On the other hand, large pets benefit fro having food divided into multiple compartments as previously described. In another version of the formed food and water package 100, a plurality of food compartments is shown separated by compartment separators 103, leaving a single open water compartment 112 for an owner to fill as part of meal preparation for the pet.

Upon completion of a meal, it is advisable to remove the formed upper food package that will e soiled after the pet consumes the food by inserting a finder into the finger recess 115 of the raised package server 114, and disposing of it. Removal of the formed upper food package as just described reveals a new, clean lower water tray 113 with a large water compartment 112 that would be filled to meet the pet's water needs for the remainder of the day.

Both the formed food package and the formed large water tray just described would be discarded after a single use, and replaced with a new formed food package containing food, nested with a new water tray, at the time of the next scheduled feeding.

FIG. 13 is an exemplary diagram illustrating an isometric view of tray variations of a nestable single serve pet food trays, pet food, packaged food topper, and a raised food package server.

In the drawing, a water tray 113 is shown resting in a raised package server 114 to that the underside of the water tray rim 119 overlaps the inner dimensions of the receiving portion of the raised package server.

A width dimension “A” is shown for comparison to the nestable packages, but the dimension is arbitrary and only used for illustrative purposes.

Now then, a variation of a multi-compartment formed food package is shown with an oversized sealing rim 117 of a dimension “A+B”, the increased width providing for a nominal overhang beyond the width “A” of the previously described water tray rim 119 to allow for easy nesting separation when removing the upper food package from the lower water tray.

As another variation, a tray removal tab may be formed extending from the perimeter of the formed food tray a total dimension of “A+C” that is greater than width “A” of the previously described water tray rim 119 to allow for easy nesting separation when removing the upper food package from the lower water tray.

It should be noted that some pet owners prefer to enhance the taste of the pet's food by pouring a medium to low viscosity flavor enhancer, referred to in the industry as a “topper”, over the food prior to serving to the pet.

In the drawing, a formed food package 100 is shown with large kibble food 301 and a food topper package 303 contained within the food compartments during the manufacturing process. In practice, a pet owner would remove the topper package, open it, and pour the contents over the food 301 before serving the food to the pet.

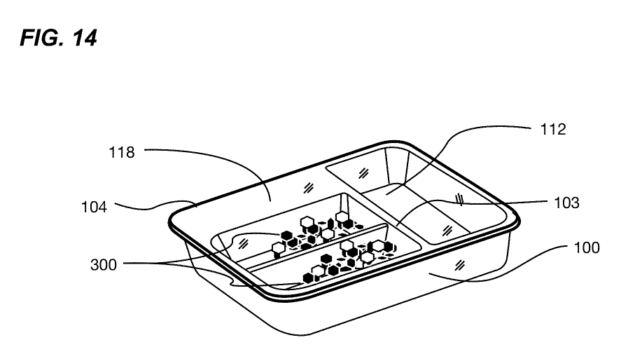

FIG. 14 is an exemplary diagram illustrating an isometric view of one variation of a multi-cavity, single serve pet food tray and pet food. It is sometimes preferred to use substantially the same tooling for the forming of a formed food package that is intended for different sized animals. It is well known that a tooling insert can be used to close off certain areas of an injection mold tool.

In the drawing, a formed food package 100 is shown with a water compartment 112 separated from a plurality of food compartments containing small kibble food 300 by means of a compartment separator 103.

In the present variation, only two-thirds of the food is required for a smaller pet compared to a larger pet for which the original formed food package was intended. As can be readily seen, an insert into an injection mold tool has resulted in the creation of a shelf area that serves as a compartment filler 118, thus reducing the food area volume, and ensuring that the food provided is positioned closer to one edge of the package providing for easier access to the food by a smaller pet.

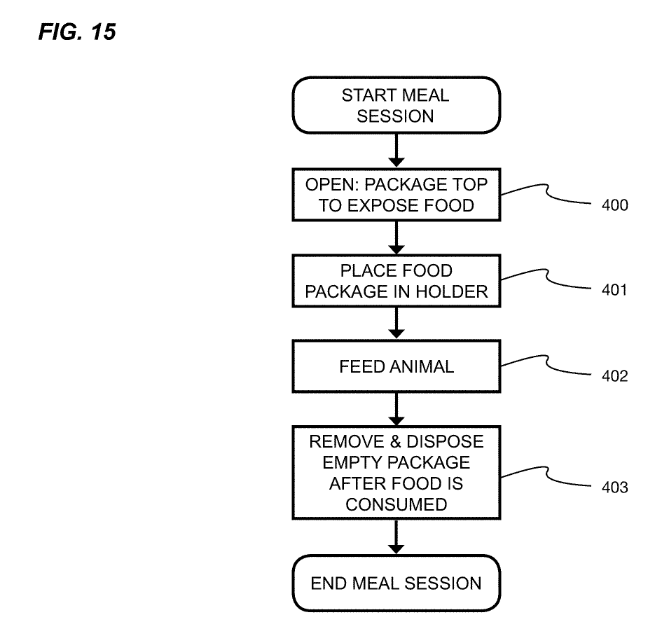

FIG. 15 is an exemplary diagram illustrating a flow chart describing one feeding process using a single serve pet food container.

A pet owner starts the meal process by retrieving a prepackaged formed food container that also serves as a feeding bowl, and opens the sealed top 400. The formed food package is placed into a package server 401 that holds the food and package securely, and feeds the pet 402. Upon complete consumption of the food by the animal, the soiled food package is removed and discarded 403.

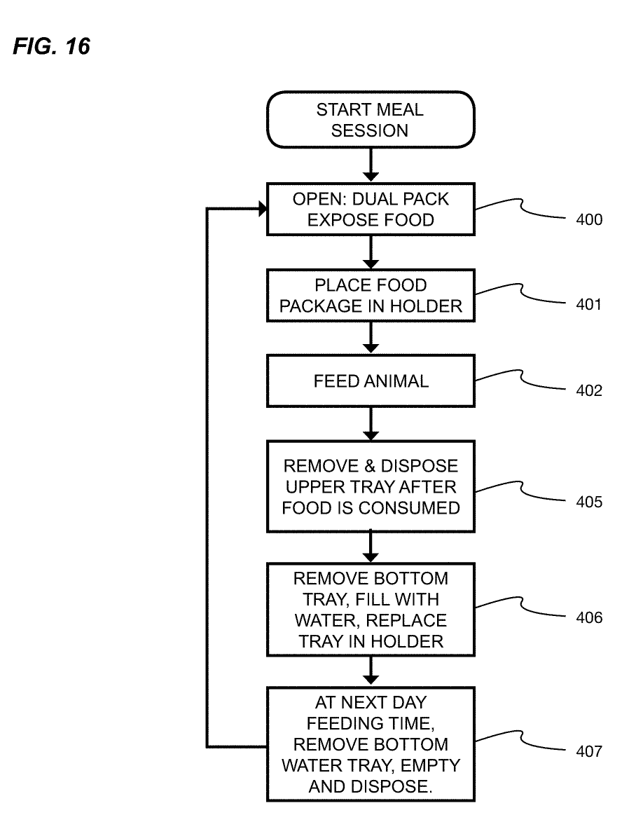

FIG. 16 is an exemplary diagram illustrating a flow chart describing one feeding process using a nestable, single serve pet food container.

A pet owner starts the meal process by retrieving a prepackaged nested formed food package containing a first upper container prepackaged with pet food, and a lower water container, and opens the sealed top 400. The nested food package is placed into a package server 401 that holds the food and package securely, and feeds the pet 402. Upon complete consumption of the food by the animal, the soiled upper food package is removed and discarded 405 revealing the lower water tray which is removed and filled with fresh water 406 and replaced in the package server. The water tray just described remains in the server, being refilled with fresh water as needed, until it is removed for insertion of a new prepackaged nested formed food package for the next feeding session 407.

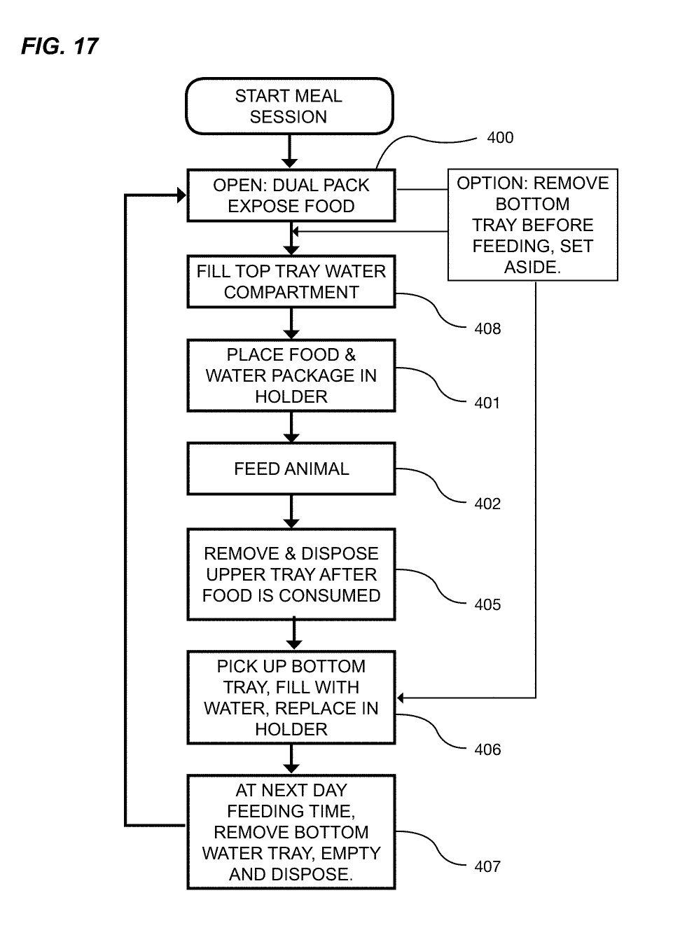

FIG. 17 is an exemplary diagram illustrating a flow chart describing one feeding process using a variation of a nestable, single serve pet food container.

A pet owner starts the meal process by retrieving a prepackaged nested formed food package containing a first upper container prepackaged with pet food and having a separate water compartment, and a lower water container, and opens the sealed top 400. The top water compartment adjacent to the prepackaged food compartment is filled with water 408.

The nested food package with food and water is placed into a package server 401 that holds the food and package securely, and feeds the pet 402. Upon complete consumption of the food by the animal, the soiled upper food package is removed and discarded 405 revealing the lower water tray which is removed and filled with fresh water 406 and replaced in the package server. The water tray just described remains in the server, being refilled with fresh water as needed, until it is removed for insertion of a new prepackaged nested formed food package for the next feeding session 407.

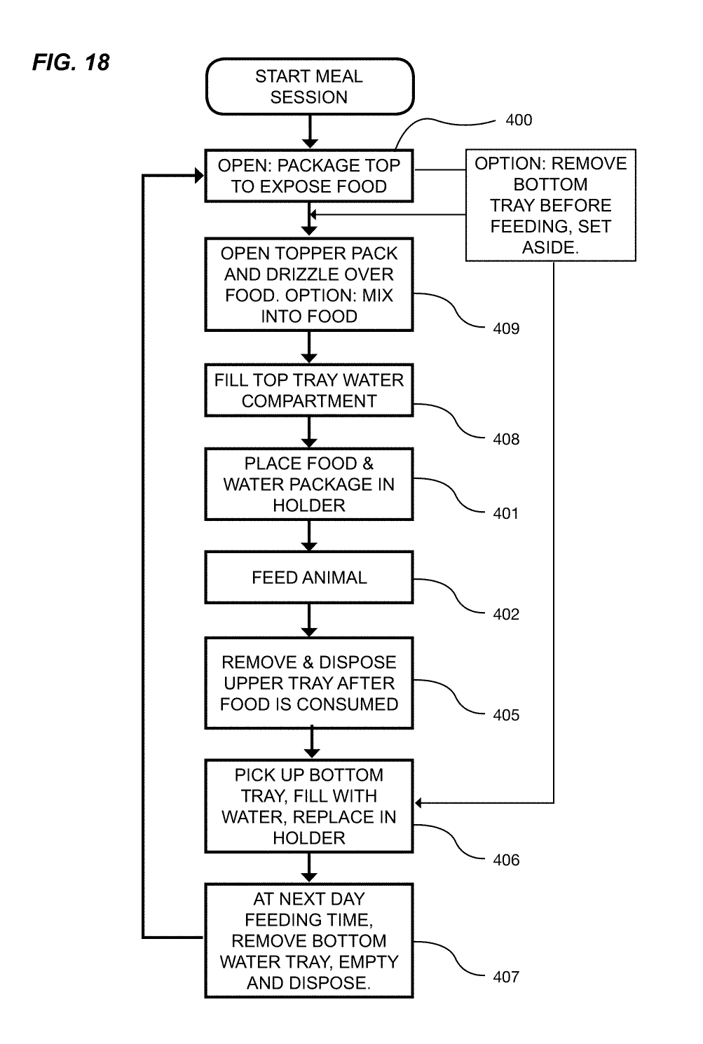

FIG. 18 is an exemplary diagram illustrating a flow chart describing one feeding process using a variation of a nestable, single serve pet food container with a pre-packaged food topper.

A pet owner starts the meal process by retrieving a prepackaged nested formed food package containing a first upper container prepackaged with pet food and having a separate water compartment, and a lower water container, and opens the sealed top 400.

A food topper package contained within the sealed multi-compartment upper tray is removed, opened and poured over the food contained therein 409. The top water compartment adjacent to the prepackaged food compartment is filled with water 408.

The nested food package with food and water is placed into a package server 401 that holds the food and package securely, and feeds the pet 402. Upon complete consumption of the food by the animal, the soiled upper food package is removed and discarded 405 revealing the lower water tray which is removed and filled with fresh water 406 and replaced in the package server. The water tray just described remains in the server, being refilled with fresh water as needed, until it is removed for insertion of a new prepackaged nested formed food package for the next feeding session 407.

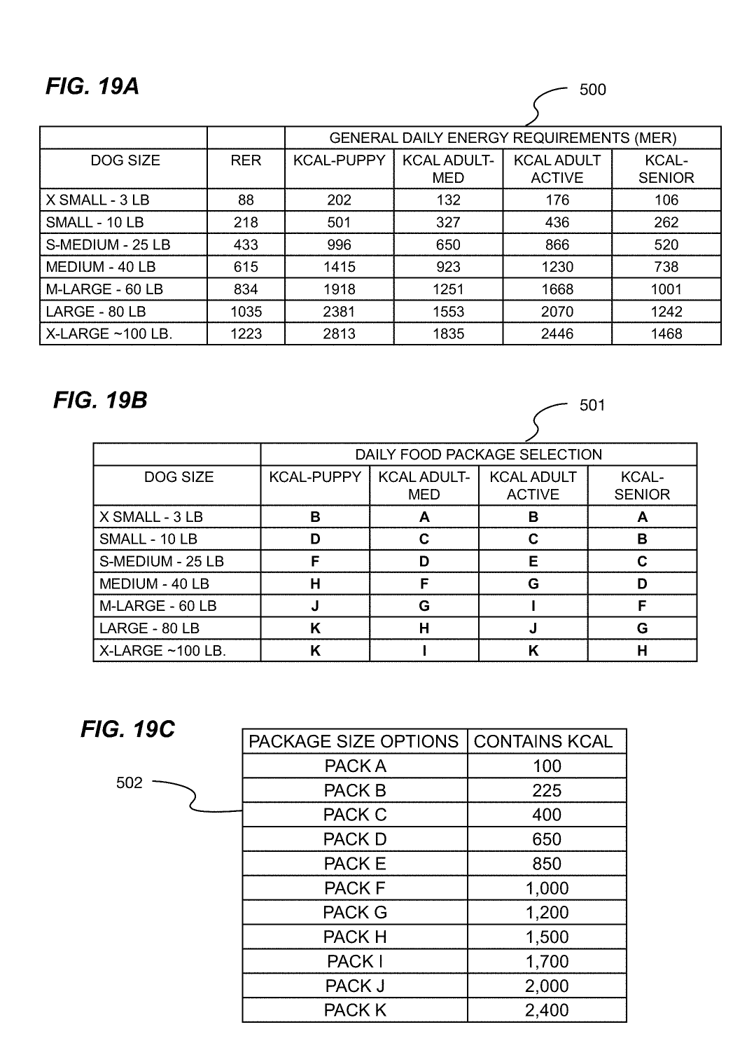

FIG. 19A is an exemplary diagram illustrating a chart listing a selection of weight-based daily caloric requirements of pet dogs.

Those skilled in the art understand that nutritional requirements between various pets vary widely, and depend in large part on the weight of the animal. They further understand that a single portion serving for one animal may be completely inappropriate for a different sized animal, or for a more active or less active animal.

Therefore, for illustrative purposes, the chart of dog calorie requirements 501 provides for an array of property portioned single-serving prepackaged disposable food packages based in part on the weight, age and activity level of the animal. Based reasonably on meeting the calorie requirements of the targeted animals, an appropriate volume of food of known calorie content can be filled into the respective single-serving packages on a manufacturing line.

FIG. 19B is an exemplary diagram illustrating a chart matching a food package size to a dog size.

The just described chart FIG. 19A, 500 would be difficult to easily communicate to an average pet owner that would purchase single serving pre-packaged pet food. Therefore, an easier method of communicating to the consumer the proper prepackage food size is shown in the chart of daily food package selection 501. In the chart, a consumer knowing the approximate weight and age of their pet would easily correlate that pet information to a particular package size. In the illustrative example, food package sizes range from “A” through “K”, although in practice, a larger or smaller number of package sizes may be offered to the consumer.

It should be noted that once a consumer knows their preferred package size, they may purchase any flavor of food, for example, beef, chicken or fish flavor, and they may purchase a wet food or dry food option knowing that the package contains one complete and balanced daily serving of the appropriate calorie content for their particular pet.

FIG. 19C is an exemplary diagram illustrating a chart showing the caloric content of various sizes of dog food packages.

Although food package selection based on calories may not be the preferred method by which a consumer would select a properly sized food package, it should be noted that a day of extraordinary pet activity, for instance, a day of hiking for an otherwise low activity pet, will result in a caloric deficiency for that day compared to other less active days.

A chart of package size options 502 provide for the purchase of add-on food packages that would supplement the regular daily food consumption.

The disposable, formed and prefilled single serving pet food packages just described, including the single and the double nested bowl packages, ensure that the pet will be eating proper food portions and drinking from new, clean, bacteria-free food and water bowls every day.

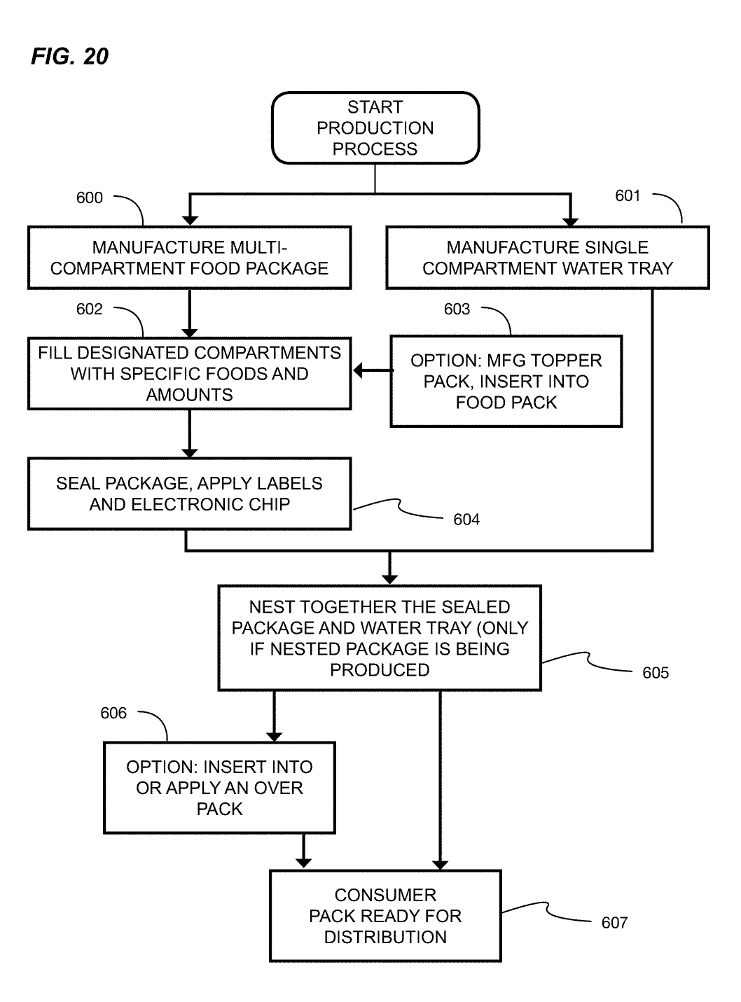

FIG. 20 is an exemplary diagram illustrating a flow chart describing one manufacturing process for producing a disposable, single serve pet food container.

Those skilled in the art will appreciate that the sequence of manufacturing and packaging food varies widely and is dependent on may production and efficiency factors including, for example, at what stage of food production is the food cooked, or at what stage of production is the food and packaging data recorded and printed on appropriate labeling.

Further, various methods of sterilization are used in food production lines, including irradiation, nitrogen injection, cooking and quick cooling, and the like, each type of sterilization process occurring at different points in a food manufacturing process. Those skilled in the art appreciate that the type of sterilization used can alter the sequence shown in the drawing without deviating from the manufacturing of an end product of the various embodiments. Consequently, the point of sterilization may occur at any reasonable stage of the manufacturing process, and is therefore not shown on the flow chart even though it is an integral stage of the production process.

Therefore, the following illustrative sequence of manufacturing steps to produce a disposable, nested single serving pet food product is not meant to be limiting, and any of the steps may be re-sequenced in the interest of efficiency without deviating form the spirit and processes to manufacture the intended end product.

In the drawing, one process of manufacturing a disposable, prefilled, nested single serve pet food product provides for the high production manufacture of an opened top, multi-compartment pet food package 600 and a separate high production manufacture of an opened top, nestable water tray 601.

In a production line, a designated amount of food, corresponding to a designated nutritional and caloric content, is filled 602 into designated compartments of a multi-compartment pet food package.

In some instances, it will be desirable to insert a separately manufactured pet food enhancer, referred to as a topper, into the multi-compartment pet food package 603 before the filled pet food container is closed and sealed.

The data related to the package of food is recorded on a readable electronic chip such as an RFID or NFC tag, and produce labels are applied. 604. The filled and sealed food package is nested into an open water tray of substantially the same overall dimension 605, the nested products being temporarily bound together by means of mechanically interfering mating details on the respective food and water trays, by over packing using a heat shrinkable wrapping, for instance, or inserted into an over pack box of bag 606. Upon completion of the over packing or nesting, the product is ready for distribution to an end consumer 607.

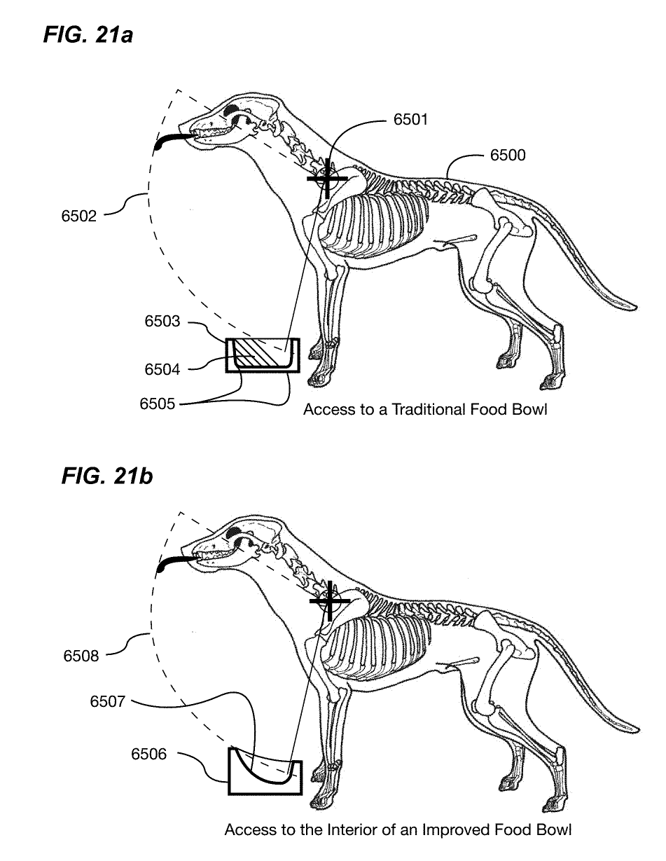

FIG. 21a is an exemplary diagram illustrating the skeletal structure of a domesticated animal with a traditional food bowl. More specifically, the natural arc of the neck of a domesticated dog reaching for a food bowl is shown. It is well known that domesticated cats and dogs share the genetic pool with their wild, carnivorous ancestors. These animals are efficiently designed to eat captured prey from the ground. In a perpetual, misguided effort to vicariously impart human personalities upon their pet dogs and cats, humans interfere with nature's designs.

More specifically, humans consider that since they eat from symmetrically designed bowls, their pets should also, or perhaps using a standard dining bowl to feed their pets is merely a convenience.

Literature teaches us many variations of animal feeding bowl designs, the great majority of which point to their human bowl roots; they are generally symmetrical, have a top rim generally coincident with a substantially horizontal plane parallel to the bowl bottom, and a generally symmetrical perimeter wall extending between the bottom interior surface of the bowl and the top rim.

In the drawing, a standard food bowl of the design just described is shown 6500 positioned in front of a skeletal representation of one type of dog 6500. All healthy dogs and cats have neck lengths generally defines as the distance between a point 6501 located at or about where the cervical vertebrae meet the thoracic vertebrae near the animal's shoulder.

As illustrated in the drawing, the animal's neck flexes at the shoulder point just mentioned, as well as throughout the cervical vertebrae and where the spine meets the skull, such that the dimension between the shoulder and mouth is intended to move in an arc 6502 in order to easily reach food placed on the ground, in the illustration, the food being a dog bowl 6503.

As can readily be seen the dog is able to reach the interior of the portion of the bowl closest to its feet, but is unable to reach the opposite side of the interior of the bowl 6504 without moving closer to the bowl, or lowering the shoulder point 6501 by crouching of bending its front legs.

Further, the majority of bowls have a traditionally small radius formed between the interior side-wall and bottom 6505 as illustrated. These radii form areas that are oftentimes smaller than an animal's muzzle, thereby preventing the animal from easily accessing food contained in these bowl bottom “nooks and crannies”. Food remaining in these areas after the animal eats foster bacteria growth, and attract unwanted insects and vermin.

It should be noted that some bowls have larger radii between the side walls and bowl bottom, but the increased radii are generally arbitrary with regard to feeding efficiently, and are more reasonably attributed to lower cost manufacturing process that use less material, or that are more easily formed when large radii are introduced.

FIG. 21b is an exemplary diagram illustrating the skeletal structure of a domesticated animal with an improved food bowl. More specifically, an improved feeding bowl 6506 is shown with a line 6507 indicating an improved geometry of the interior food surface of the improved bowl.

As one means of improving animal access to food in a manner that accommodates the animal's skeletal structure, the curve of the food surface 6507 is therefore more closely aligned with the arc 6508 formed by the natural neck-bending movement used by dogs and cats when naturally eating prey.

More specifically, not shown is the fact that animals also flex their necks at the point where the cervical spine meets the skull. The arc formed by the animal's nose when flexing the scull as just described is of a smaller radius than the arc 6508 shown. Therefore, the surface geometry of the food surface 6507 of the bowl of at least one embodiment of the present invention, anticipating a secondary arc radius, is further modified based on converging radii, as may be represented by a portion of a traditional drawing tool, the French Curve.

Those skilled in the art will immediately appreciate that the apparent center of the bottom of the interior food surface is not co-located with the apparent center of the bowl structure, the center of the food surface therefore being positioned closer to the feeding animal than the center of the bowl structure. This provides for a more natural access to food, and further eliminates the hard-to-reach areas of traditional food bowls as previously described FIG. 21b, 6504, 6505.

As will become more apparent, the food bowl of at least one embodiment of the present invention therefore provides for a feeding surface correlating more closely to the normal range of motion exhibited by feeding carnivores, eliminates or substantially reduces inaccessible portions of the interior of the bowl thereby reducing inaccessible food that attracts insects and vermin, and provides for substantially increased radii between the bowl bottom and sidewalls that can reduce manufacturing tooling costs.

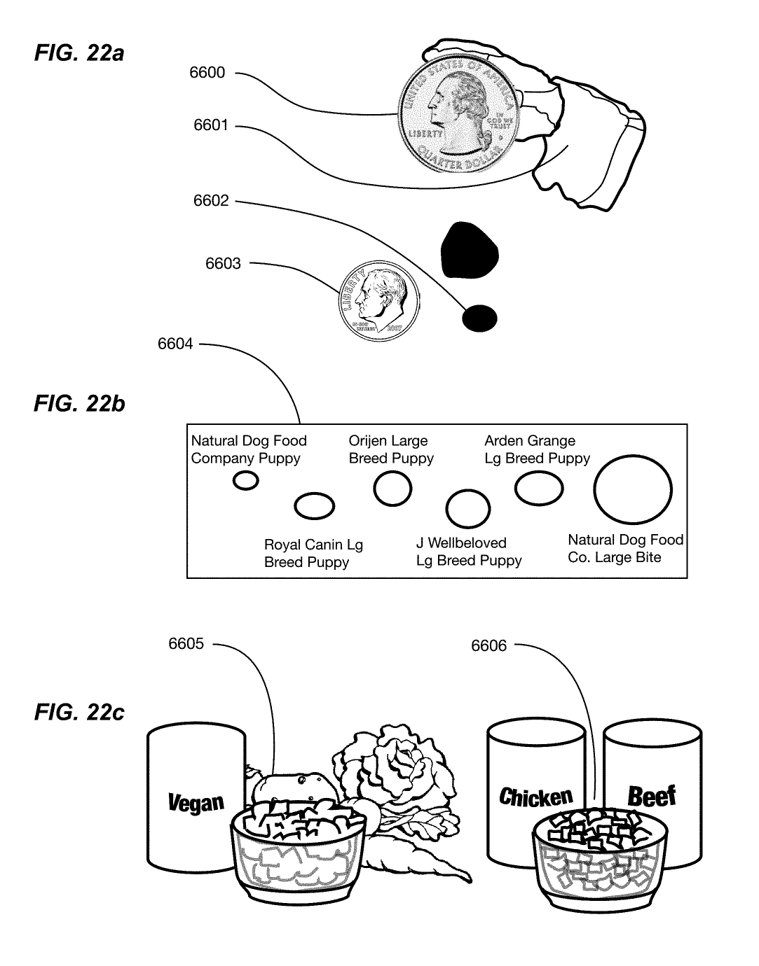

Notwithstanding the benefits of the improved feeding surface of a food bowl, it is sometimes preferred to slow the actual rate of consumption in order to avert the onset of certain medical conditions as previously described. FIG. 22a is an exemplary diagram illustrating the size of dry kibble food relative to coin sizes. More specifically, carnivores can exhibit aggressive eating habits such as food gulping that can result in life-threatening conditions. In the wild, carnivores typically dine on natural food that is moist. The higher moisture content can aid in easing consumption, provide increased satiation and be easier to swallow when compared to the ubiquitous dry food currently manufactured and sold for dogs and cats.

Special consideration should be given by pet owners to method of slowing the rate of consumption of manufactured food to thereby decrease the incidence of GDV and food aspiration.

In the drawing, two coins are shown, a US dime 6603 and US quarter 6600. As a means to illustrate the wide range of nugget sized of manufactured dry food, one piece of one exemplary dry food 6601 is shown next to the quarter, the quarter providing a dimensional point of reference.

In the same drawing, two additional pieces of dry food are shown, with one piece 6602 being a dimension that is approximately 1/10th of the size of the dime 6603.

By comparing the two food nuggets 6601, 6602, one can readily see that the larger nugget is estimated to be approximately 20 times the size of the smaller nugget. Further, it can readily be seen that the larger nugget has sharp, jagged edges compared to the smaller, well-rounded nugget.

FIG. 22b is an exemplary diagram illustrating the size of dry kibble food relative to other kibble sizes. As a further comparison of the small nugget 6602, the drawing 6604 shows six additional nuggets representing just six of the literally hundreds of nugget brands and sizes. Methods intended to slow consumption of dry food should reasonably consider the size variations of nuggets. Although not shown, the significant body of art related to protrusions or obstacles within the feeding bowl teaches the functional design requirements of such protrusions or obstacles being the size of a dog's or cat's snout, or muzzle. This teaches away from food kibble size being the driving design parameter for devices intended to slow food consumption, and disregard the vagaries in food nugget differences that can actually interfere with the intended functionality of the art.

It should be noted that in some teachings, the space between protrusions would be insufficient to accommodate the large nuggets just described, while allowing the small nuggets to fall so deeply between protrusions that it remains unreachable by animals with short tongues—the only method they have to extract food from between protrusions. Further, the current body of art teaches protrusions that are largely of non-resilient construction that can cause irregularly sized or shaped nuggets to become lodged between or around the protrusions, the art remains silent as to intended functionality being useful when feeding highly irregular shapes and sizes of nuggets.

FIG. 22c is an exemplary diagram illustrating the two variations of canned dog food. By comparing the consistency of the wet canned food 6605, 6606 to the dry kibble nuggets just described, it can be readily seen that wet food can be messier, and leave considerably more residue and un-eaten food bits stuck to the food surface. As can further observed in the exemplary examples of just two of the hundreds of versions of canned dog and cat food, consistency and “chunkiness” varies considerably even between canned food, with one version 6605 being of a “mashed potato” consistency, and the other 6606 being more of a chunky “meat stew” consistency.

The current body of art related to devices intended to slow food consumption teaches away from the use of canned food since use of canned dog and cat food for obvious commercial reasons, those being that an owner would be required to first “pack” the canned food between or around protrusions or obstacles, then after the animal finishes eating, would then be required to clean the un-eaten food and wet food residue from in and around each obstacle. Therefore, suppliers of such products focus general recommendations only on the use of dry food nuggets, further remaining silent on issues related to nugget size as just mentioned.

Skilled artisans will immediately appreciate that the body of food-slowing art fails to solve the problems just described, and in some cases cause or exacerbate feeding problems, and will further appreciate the device of at least one embodiment of the present invention that preferably slows food consumption while accommodating all of the various sizes, shapes and consistencies of dry, moist or wet dog or cat foods.

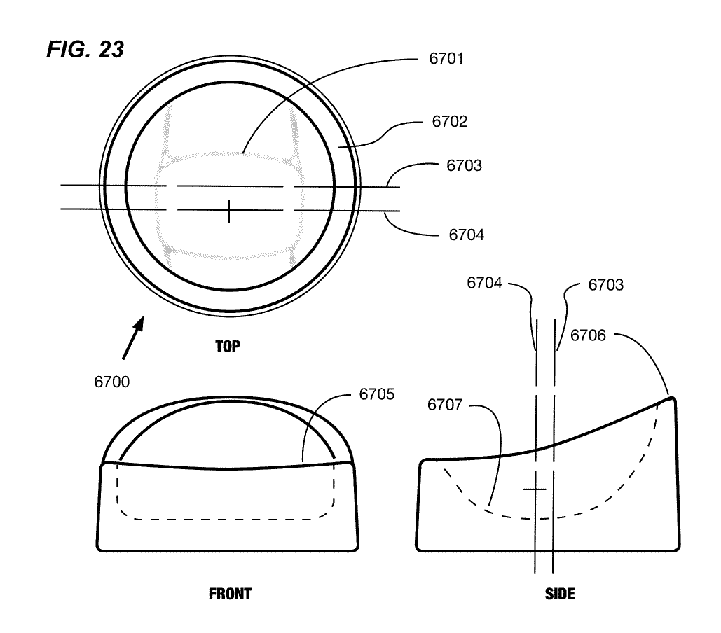

FIG. 23 is an exemplary diagram illustrating three views of an improved food bowl 6700. In the drawing, the top view of the bowl shows a substantially circumferential perimeter, not unlike traditional round bowls. The bowl of at least one embodiment of the present invention also comprises a top rim 6702, and an interior food surface 6701 therein providing a reservoir for holding food.

Deviating from traditional animal food bowls not shown, but comprising a substantially concave or recessed food surface of substantially symmetrical geometry about the centerline of the bowl, it can be readily seen that the centerline of the approximate bottom food surface 6704 is offset to the front of the bowl relative to the actual center of the bowl structure 6703. The function behind the offset, and the advantages thereof, will soon become known.

Now, in the side view, the dotted line 6707 indicating one view of the interior food surface, shows a sharper drop into the bowl on the front, while a longer, sweeping arc as it rises to the back side. Consistent with the correlation to an animal's natural neck arc, the deeper front correlates to the ease with which an animal can reach its mouth closer to the ground on the proximal side of the bowl, and less ease with reaching food at the same level when the food is on the distal side of the bowl.

As can be realized in this view, the long sweep of the back end of the bowl, extending from the higher rim 6706, moves the actual centerline 6704 of the bottom of the interior bowl to a point closer to the animal when compared to the actual center of the bowl exterior 6703.

It should be noted that the distance of the actual offset between the interior center and center of the exterior structure is not a defined distance, and may change depending on the overall dimensions of the bowl, as well as the intended type and size of animal for which the bowl is designed. However, those skilled in the art will appreciate that the offset of at least one embodiment of the present invention represents a new and novel positioning of food that corresponds more closely to a carnivore's natural head and neck movements when compared to traditional, symmetrically structured food bowls.

It should also be noted that the front end of the top rim 6705 is positioned at a distance above the bottom edge of the bowl when compared to the top rim 6706 at the back end of the bowl. The new and novel invention positions the food in a bowl wherein the natural feeding action tends to push food from the front, to the back of the bowl, where the animal reaching for food at the back of the bowl more easily ingests the food since it is higher along the natural neck and head arc.

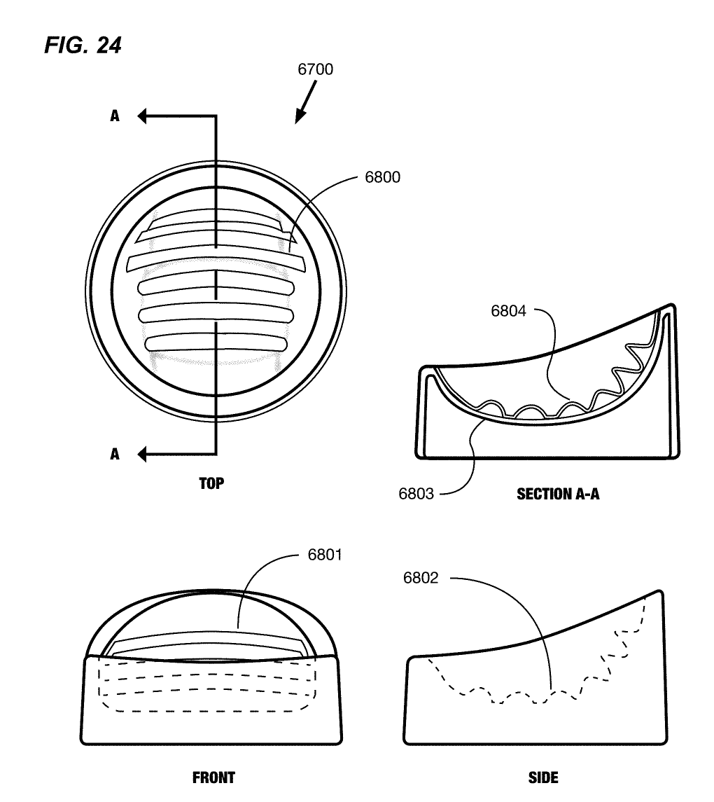

FIG. 24 is an exemplary diagram illustrating three views of an improved round food bowl with a food obstacle. In the drawing, a food bowl 6700 of at least one embodiment of the present invention is shown with a food obstacle 6800 introduced into the interior of the food containing area. The obstacle is intended to separate food into a plurality of troughs within the food area, thereby requiring an animal to separately extract food from a multitude of discrete food partitions. This requirement achieves the objective of discouraging the dangerous practice of food gulping, and helps minimize food aspiration.

At least one embodiment of the present invention further solves previously described problems, namely obstacles not accommodating different dimensions of dry food nuggets, not accommodating wet foods, and un-reachable food resulting in unsanitary conditions that attract insects and vermin.

In consideration of the above, it can be immediately seen that the obstacles are uniquely arranged as terraces 6801, and/or crests and troughs with the major longitudinal axis of the terraces and troughs arranged substantially perpendicular to the axis now shown, but which axis runs from the front to the back of the bowl. The bottom of the terraces and troughs, as shown in the imaginary line 6802 in the side view of the drawing, generally follows the interior geometry of the novel food surface as previously described.

More specifically, either as a component of the formation of the food surface 6803, or an insert 6804 placed in communication with a curved structure approximating the desired food surface of at least one embodiment of the present invention as shown in the sectional view, it is readily apparent that the obstacles extend substantially from the front of the bowl, to the higher portion of the food surface arc at the back of the bowl. This ensures that as the animal inherently pushes food away from them, as their head and tongue extend from the natural arc as previously described, the intended consumption-slowing function will continue to perform as intended even as food is pushed away onto higher levels, and into higher-positioned troughs and terraces.

Obstructions arranged in a pattern generally perpendicular to the direction an animal would naturally push food while eating are substantially more effective in extending the time required to consume a specified volume of food when compared to troughs with a primary axis parallel to the front-to-back axis of the bowl. In such a non-preferred arrangement, the animal would have the ability to gulp or lap up food quickly simply be cleaning out each trough by running their head and tongue from front to back in a natural movement, thereby cleaning out each trough with a minimum of effort, and in a minimum of time.

Therefore, while the troughs, crests and terraces just described run generally perpendicular to the major front-to-back axis of the bowl, the specific orientation is not meant to be limiting, and that variations not shown, such as chevron configurations, basket-weave configurations, or angles of the obstacles relative to the front-to-back axis of the bowl ranging from an acute angle relative to the front of the bowl, to an obtuse angle relative to the front of the bowl maybe used, so long as the front-to-back pushing of food by the animal inhibits the animal's use of troughs as furrows from which it can quickly gulp or scoop food.

It should be further noted that the geometric shape of the food surface 6803, the terraces and troughs of the insert 6804, or the precise orientation of the obstacles relative to the front-to-back axis of the bowl are not meant to be limiting. These dimensions are a function of the size of, and neck length of various animals, and additionally a function of the food an owner intends to feed their animal. Therefore, there can be more or fewer obstructions, obstructions placed further apart or closer together, or obstructions that have a height dimension that is greater or smaller than shown, all without deviating from the spirit or intention of the novel function provided by at least one embodiment of the present invention.

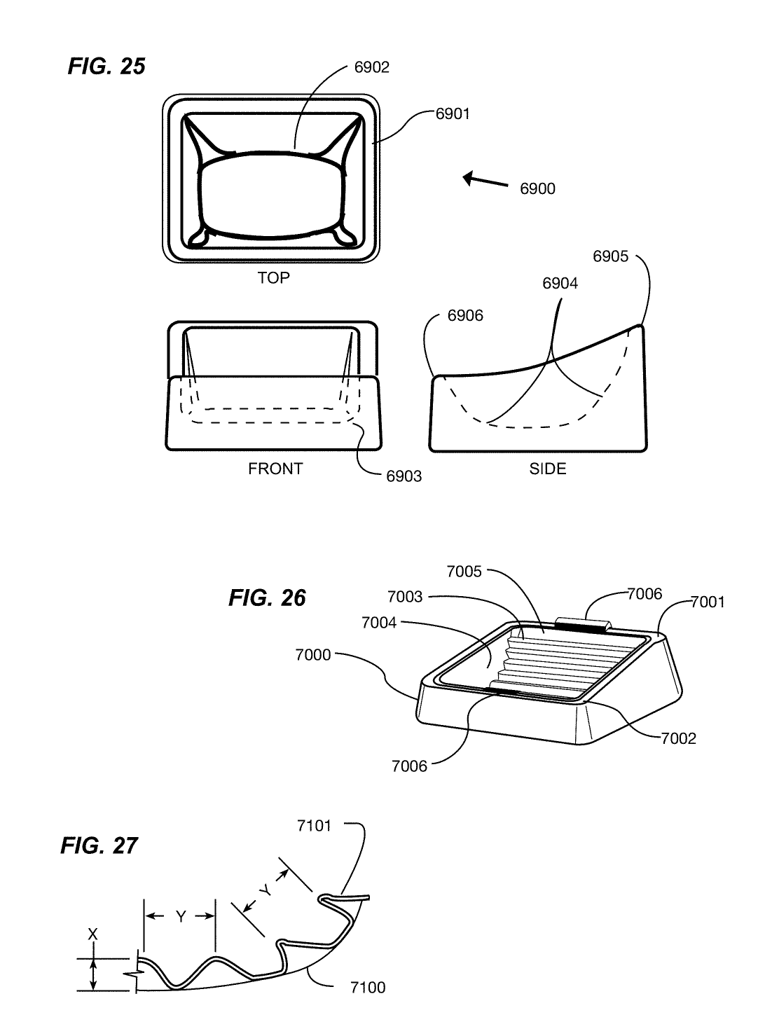

FIG. 25 is an exemplary diagram of one version of an improved food bowl. More specifically, the drawing shows a food bowl 6900 of at least one embodiment of the present invention as a rectilinear variation, thus retaining all of the foregoing beneficial improvements previously described, but incorporated into a rectilinear top rim 6701 and structure, rather than a circumferential structure.

One will immediately see that the approximate centerline of bottom of the food surface 6902, as measured between the front and back of the bowl, is offset towards the front of the bowl as previously described.

Further, the variation of the improved food bowl comprises a top rim 6906 at the front of the bowl, and a top rim 6905 positioned at the back of the bowl, the top rim at the back of the bowl being positioned at a dimension from the bottom of the bowl that is larger than the dimension of the front rim.

In order to follow the natural neck and head arc of an animal feeding from the improved bowl, the feeding surface, as indicated by the dotted line 6904 shown in the side view, the arc of the feeding surface towards the back of the bowl must accommodate a longer sweep that lifts the food to a higher position more aligned with the position of the animal's mouth as it extends its neck and head further toward the back of the bowl.

In order to solve one previously discussed problem with traditional feeding bowls, the radii 6903 that create the curved feeding surface between the interior side walls of the bowl, and the bottom food surface, are increased to a dimension such that easy access by animals with wide muzzles is maintained, and so that food is easily accessible, and therefore does not collect and create unsanitary conditions in the “nooks-and-crannies”. It will be further appreciated that the large radii of the entirety of the interior food surfaces of the improved bowl are all maintained as a generally larger dimension when compared to interior radii of traditional food bowls, thereby making it easier for the bowl to be rinsed or cleaned.

FIG. 26 is an exemplary diagram illustrating an isometric view of an improved rectilinear food bowl with an insert comprising food obstacles. In the drawing, an improved food bowl 7000 is of a generally rectilinear footprint upon a floor surface not shown, comprises a lower top rim 7002 towards the front edge of the bowl, and a higher top rim 7001 towards the back edge of the bowl, the different heights from the bottom plane of the bowl being responsive to the natural neck and head arc exemplified by a dog or cat eating from the bowl.

An insert 7005 comprising food consumption obstacles is shown positioned within the interior surface of the bowl, the insert therefore conforming to the interior food bowl geometry as previously described. Although the insert is shown being retained within the interior surface of the bowl by a front latch and a back latch 7006, the latches are shown merely as one exemplary example of many possible mechanical and electromechanical means of removably retaining one component in communication with another component, those being electromagnets, mating detents and posts on the mating parts, edges of a resilient insert being retained under the inside edge of an outer bowl shell, mating hook and loop fastening systems, or any other number of removable fastening or mating devices or mechanisms well known to those skilled in the art.

Therefore, the form and method of retaining an obstacle insert within the interior feeding area of a pet food bowl are not meant to be limiting, and any appropriate method or device that retains an obstacle insert within the improved food bowl may be used without deviating from the object of at least one embodiment of the present invention.

Now, it can be readily seen that the insert 7006 comprises a plurality of obstacles 7004 that may further comprise terraces or troughs with a primary longitudinal axis substantially perpendicular to the axis of the front-to-back centerline of the bowl, the orientation of the terraces and troughs intended to create a plurality of food retaining areas. The requirement of an animal to separately remove food from each food retaining area, either separated by terrace-like structures on the back wall as the surface transitions from substantially horizontal in the bowl bottom, to a more vertical orientation along the back surface, or separated by troughs, provides for slower food consumption, and therefore acts to diminish or eliminate the previously described problems associated with good gulping.

Further, sidewalls 7004 are shown on the obstacle insert, thereby providing for complete coverage of the food surface geometry of the improved food bowl by the insert. The full and complete coverage of the bowl interior by an insert is a preferred method of ensuring that food is not accidentally repositioned to the space between the insert and bowl by the animal's act of eating.

Therefore, the entire obstacle being a single food surface, the removable insert, preferably being of a slightly resilient and bacteria-inhibiting material such as silicone generally of a Shore A range of 40 to 60, can be easily removed and cleaned. The resiliency prevents food particles from becoming lodged into or otherwise retained by the rigid protrusion food obstacles taught by traditional slow food consumption products, and further provides for sanitation by high temperature washing systems such as a dishwasher.

It should be noted that the materials just mentioned are not meant to be limiting, and rigidly formed materials may be used provided the obstacle sizes and positioning of obstacles upon the insert provide the preferred function of at least one embodiment of the present invention as described.

FIG. 27 is an exemplary diagram illustrating a sectional view through a typical insert with integral obstacles. More specifically, a series of terrace-like and trough-creating structures 7101 extending substantially upward or outward from the bottom portion of the insert 7100 into the interior food space of an improved food bowl are shown. The positioning of each trough or terrace relative to the other as indicated by dimension “Y”, and the dimension that each terrace or crest between troughs extends inward into the food area “X” are not arbitrary, and change based on a plurality of factors as previously described.

Merely by example, if dry food nuggets of the type 6601 of FIG. 22a. are being fed to an animal, the dimensions just mentioned will be considerably larger than the dimensions required to appropriately separate food containing areas for dry nuggets of the smaller size 6602 of FIG. 66a.

The various embodiments include a container having a floor, a sidewall extending upwardly from the floor, and an upper opening defined by an upper perimeter of the sidewall. The floor and sidewall define an interior space that is connected to the upper opening. A volume of dry kibble food pellets is preferably positioned within the interior space of the container (the dry kibble food pellets have a diameter). The floor includes a plurality of projections that extend upwardly into the interior space. The plurality of projections are spaced apart at a distance and height sufficient so that the dry kibble food pellets are positionable between the plurality of projections in a manner that ensures an animal is required to take more time to pull the dry kibble food pellets from the container to slow the eating process. A top closure may be attached to the upper perimeter of the sidewall in a sealed manner to seal the dry kibble food pellets within the interior space. The top closure may be partially or fully opened to allow access to the dry kibble food pellets by the animal.

The sidewall may be comprised of a single wall or a plurality of walls. The container may have various shapes such as square, rectangular, round, oval and the like.

The projections may be comprised of separator walls that define a plurality of food compartments within the container, wherein the separator walls are formed to ensure that the depth of each food compartment relative to the width of each food compartment is of a sufficient ratio so as to accommodate the approximate average width of the snout of the animal. A pre-packaged food topper may be positioned within the interior space of the container and further may be positioned within one of the food compartments.

The plurality of projections may be substantially parallel to one another defining a plurality of troughs that receive the dry kibble food pellets. The plurality of projections may also be substantially parallel with respect to a front wall of the container. The floor of the container may be angled upwardly from the front to the back of the container.

Unless otherwise defined, all technical and scientific terms used herein have the same meaning as commonly understood by one of ordinary skill in the art to which this invention belongs. Although methods and materials similar to or equivalent to those described herein can be used in the practice or testing of the pet food feeding system, suitable methods and materials are described above. All publications, patent applications, patents, and other references mentioned herein are incorporated by reference in their entirety to the extent allowed by applicable law and regulations. The pet food feeding system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A pet feeding container, comprising:
a container having a floor, a sidewall extending upwardly from the floor, and an upper opening defined by an upper perimeter of the sidewall;
wherein the floor and sidewall define an interior space that is connected to the upper opening;
wherein the interior space is configured to receive a volume of dry kibble food pellets, wherein the dry kibble food pellets have a diameter;
wherein the floor includes a plurality of projections that extend upwardly into the interior space;
wherein the plurality of projections are spaced apart at a distance sufficient so that the dry kibble food pellets are positionable between the plurality of projections in a manner that ensures an animal is required to take more time to pull the dry kibble food pellets from the container to slow the eating process;
wherein the plurality of projections extend upwardly at a height sufficient so that the dry kibble food pellets are positionable between the plurality of projections in a manner that ensures an animal is required to take more time to pull the dry kibble food pellets from the container to slow the eating process.

2. The pet feeding container of claim 1, wherein the sidewall is comprised of a plurality of walls.

3. The pet feeding container of claim 1, wherein the container has a substantially rectangular shape.

4. The pet feeding container of claim 1, wherein the projections are comprised of separator walls that define a plurality of food compartments within the container, wherein the separator walls are formed to ensure that the depth of each food compartment relative to the width of each food compartment is of a sufficient ratio so as to accommodate the approximate average width of the snout of the animal.

5. The pet feeding container of claim 4, including a pre-packaged food topper positioned within the interior space of the container.

6. The pet feeding container of claim 5, wherein the pre-packaged food topper is positioned within one of the food compartments.

7. The pet feeding container of claim 1, including a pre-packaged food topper positioned within the interior space of the container.

8. The pet feeding container of claim 1, wherein the plurality of projections are substantially parallel to one another defining a plurality of troughs that receive the dry kibble food pellets.

9. The pet feeding container of claim 8, wherein the plurality of projections are substantially parallel with respect to a front wall of the container.

10. The pet feeding container of claim 9, wherein the floor is angled upwardly from the front to the back of the container.

11. A pet feeding container, comprising:
a container having a floor, a sidewall extending upwardly from the floor, and an upper opening defined by an upper perimeter of the sidewall;
wherein the container is disposable;
wherein the floor and sidewall define an interior space that is connected to the upper opening;
a volume of dry kibble food pellets positioned within the interior space of the container, wherein the dry kibble food pellets have a diameter;
wherein the floor includes a plurality of projections that extend upwardly into the interior space;
wherein the plurality of projections are spaced apart at a distance sufficient so that the dry kibble food pellets are positionable between the plurality of projections in a manner that ensures an animal is required to take more time to pull the dry kibble food pellets from the container to slow the eating process;
wherein the plurality of projections extend upwardly at a height sufficient so that the dry kibble food pellets are positionable between the plurality of projections in a manner that ensures an animal is required to take more time to pull the dry kibble food pellets from the container to slow the eating process; and
a top closure attached to the upper perimeter of the sidewall in a sealed manner to seal the dry kibble food pellets within the interior space, wherein the top closure may be partially or fully opened to allow access to the dry kibble food pellets by the animal.

12. The pet feeding container of claim 11, wherein the sidewall is comprised of a plurality of walls.

13. The pet feeding container of claim 11, wherein the container has a substantially rectangular shape.

14. The pet feeding container of claim 11, wherein the projections are comprised of separator walls that define a plurality of food compartments within the container, wherein the separator walls are formed to ensure that the depth of each food compartment relative to the width of each food compartment is of a sufficient ratio so as to accommodate the approximate average width of the snout of the animal.

15. The pet feeding container of claim 14, including a pre-packaged food topper positioned within the interior space of the container.

16. The pet feeding container of claim 15, wherein the pre-packaged food topper is positioned within one of the food compartments.

17. The pet feeding container of claim 11, including a pre-packaged food topper positioned within the interior space of the container.

18. The pet feeding container of claim 11, wherein the plurality of projections are substantially parallel to one another defining a plurality of troughs that receive the dry kibble food pellets.

19. The pet feeding container of claim 18, wherein the plurality of projections are substantially parallel with respect to a front wall of the container.

20. The pet feeding container of claim 19, wherein the floor is angled upwardly from the front to the back of the container.
